(19) United States
(12) Patent Application Publication
(10) Pub. No.: US 2005/0062850 A1
(43) Pub. Date: Mar. 24, 2005

(54) AV DEVICE HAVING AN OPTIMIZATION PROGRAM AND METHOD FOR OPTIMIZING AV SIGNALS

(76) Inventor: Yu-Chieh Lin, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/707,353

(22) Filed: Dec. 8, 2003

(30) Foreign Application Priority Data
Sep. 8, 2003 (TW) 092124735

(51) Int. Cl. H04N 5/225; H04N 9/04; H04N 7/173; H04N 7/16

(52) U.S. Cl. 348/207.1

(57) ABSTRACT

A method for optimizing audiovisual (AV) signals includes storing an optimization program into a memory of an AV device, and executing the optimization program by a host computer to process the AV signals stored in the memory after connecting the memory to the host computer.

### BACKGROUND OF INVENTION

1. Field of the Invention

The present invention relates to an audiovisual (AV) device and a method for optimizing AV signals, and more specifically, to an AV device having an optimization program and a method for using a host computer to execute the optimization program in order to optimize the AV signals.

2. Description of the Prior Art

As the information industry progresses, digital products are replacing conventional analog products daily, and AV devices are no exception. As for cameras, conventional camera use photo-sensing chemicals on a film to record images, which requires complicated development to reproduce the images. Moreover, if special effects are required, techniques using the stop, the shutter, filters or special development procedures are necessary. These techniques are often impossible for amateur users. Compared with the conventional camera, digital cameras use photo sensors to convert images into digital signals that are stored in a memory. Most digital cameras have an LCD display for browsing the images, and can be connected to a computer system to store the images on its hard disk drive and output them using a monitor or a printer. The computer system allows the user to process the images captured by the digital camera using image processing programs to create special effects similar to conventional cameras, or even special effects that are impossible for conventional cameras to produce.

There are a variety of factors that influence the image quality of digital cameras during both the digital data processing and the optical processing. Photo sensors in the digital camera influence not only the pixel size, but also the color, contrast, and brightness of the image. Charged coupled devices (CCDs) and complementary metal-oxide semiconductors (CMOSs) are the two main types of photo sensors used in digital cameras. CCD has advantages such as low noise, high sensitivity, as well as disadvantages such as high power consumption, necessity on complete charge transmission and incapability of random pixel access. On the contrast, CMOS has advantages such as low cost, low power consumption, integration of functions on a single chip, and capability of random pixel access, as well as disadvantages such as high noise, and low sensitivity. Therefore in general, CCD is used in high-level digital cameras while CMOS is used in economic digital cameras.

A digital signal processor (DSP) is the main device for processing data in the digital camera. In general, high-level digital cameras use high-level DSPs, which process image signals more efficiently and rapidly to process signals in a shorter time and then store them into a memory, while economic digital cameras use low-level DSPs as well as CMOS photo sensors, producing a lower image quality, due to a concern on the cost.

As mentioned above, digital cameras use photo sensors to convert images into digital signals, which are then stored in a memory. These digital signals are initially processed by the processor of the digital camera and displayed by the LCD display. High-level digital cameras use CCD for its photo sensor, which capture images with lower noise, high sensitivity and high quality. Economic digital cameras uses cheaper CMOS, which capture images with high noise, low sensitivity and low quality. For users of economic digital cameras, the images need to be stored in the computer system and processed with image processing programs by a central processing unit (CPU) of the computer system for better image quality. However, the image processing programs do not necessarily exist for every computer system, and the program operation frequently differs between programs. Amateur users may not have such kind of knowledge on image processing, and even if they have, it is not easy to have a good command on it.

### SUMMARY OF INVENTION

It is therefore a primary objective of the present invention to provide an AV device having an optimization program and a method for using a host computer to execute the optimization program in order to optimize the AV signals, in order to solve the problems mentioned above.

Briefly summarized, an AV device includes an optimization program executed by a host computer when the AV device is connected to the host computer, in order to optimize AV signals captured by the AV device, and a memory for storing the optimization program and the AV signals captured by the AV device.

The present invention further provides a method for optimizing AV signals including storing an optimization program into a memory of an AV device, and executing the optimization program by a host computer to process the AV signals stored in the memory after connecting the memory to the host computer.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an AV device according to the present invention.

FIG. 2 is a block diagram of FIG. 1.

FIG. 3 is a flowchart of the method for optimizing AV signals according to the present invention.

### DETAILED DESCRIPTION

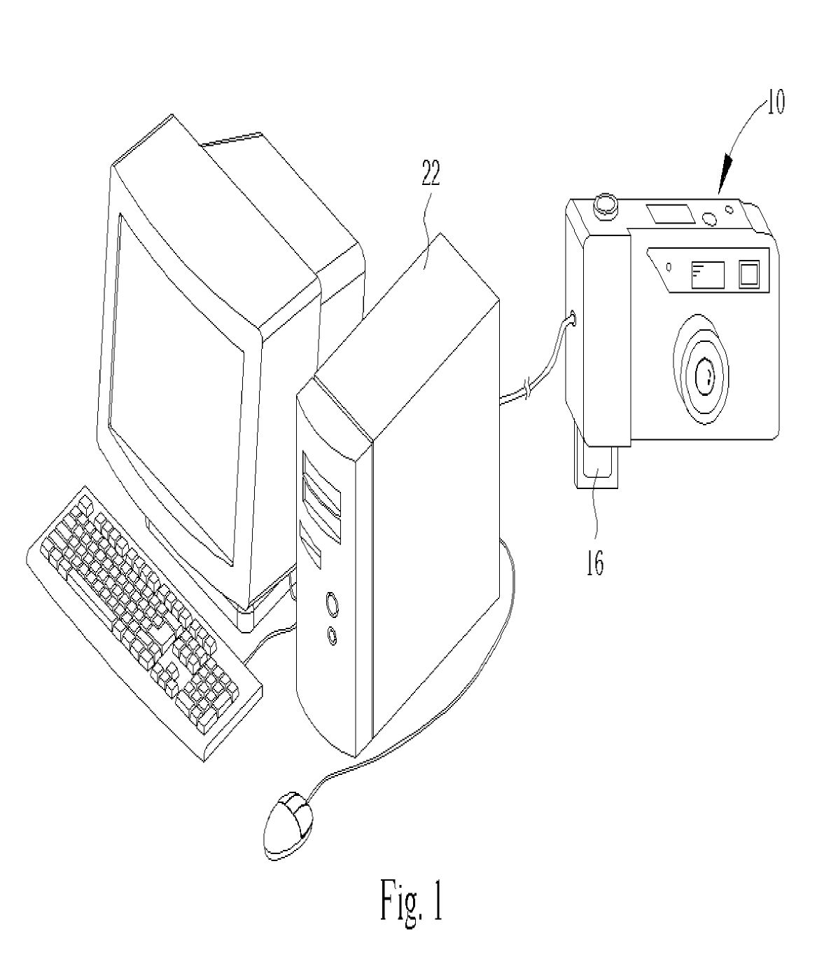

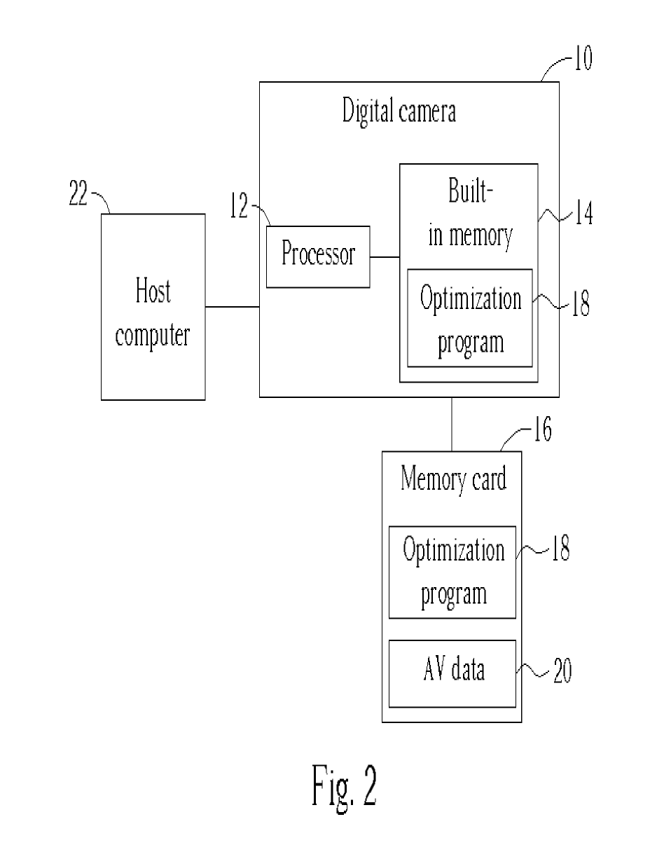

Please refer to FIG. 1 showing an AV device, and FIG. 2 showing a block diagram of FIG. 1 according to the present invention. The AV device is an AV signal capturing or memory device such as a digital camera, a digital recording pen, or a memory card. In this embodiment, a digital camera 10 with a memory card 16 is taken as an example. The digital camera 10 includes a processor 12 and a built-in memory 14. The processor 12 is for processing image signals captured by the digital camera 10 and storing them into the built-in memory 14 or the memory card 16. The built-in memory 14 can be a read-only memory (ROM)for storing an optimization program 18 and programs necessary for operating the digital camera 10, or a flash memory for storing the optimization program 18, the programs necessary for operating the digital camera 10, as well as the image signals captured by the digital camera 10. The digital camera 10 has an external memory card 16 for storing the image signals captured by the digital camera 10, which is regarded as a removable storage device when the digital camera 10 is connected to the host computer 22, so that the host computer 22 can access data stored in the built-in memory 14 and the memory card 16. In addition, the memory card 16 can be connected to the host computer 22 through a card reader, and in this case, the memory card 16 is also regarded as a removable storing device of the host computer 22. When the removable storing device is connected to the host computer 22, the host computer 22 automatically executes files in the removable storing device, such as the host computer 22 automatically plays music after a music CD is inserted thereunto. Before using the memory card 16, it is necessary to initially set up the memory card 16. Setting up the memory card 16 involves recording a storing format of the digital camera 10 in the memory card. According to the present invention, besides the initial setup, the digital camera 10 copies the optimization program 18 stored in the built-in memory 14 to the memory card 16, and configures the optimization program 18 to be a file automatically executed when the memory card 16 is connected to the host computer 22. In such a manner, whenever the memory card 16 is connected to the host computer through the digital camera 10 or the card reader, the host computer 22 will automatically execute the optimization program 18 to process the AV signals captured by the digital camera 10. The optimization program 18 is designed according to hardware characteristics of the digital camera 10 or has parameters corresponding to hardware characteristics of the digital camera 10. The host computer can optimize the AV signals captured by the digital camera 10 using the program. Such optimizations include improving the noise, brightness or contrast. Moreover, the optimization program 18 is executed by the host computer 22 when the digital camera 10 is connected to the host computer 22. Since the host computer 22 has a better CPU, the optimization program 18 is executed rapidly so that the digital camera 10 requires only a basic processor 12 to process the images. The image processed by the optimization program 18 is stored back in the memory card 16 to rewrite the original data, and an index is attached for identification. In such a manner, the AV signals captured by the digital camera 10 are optimized.

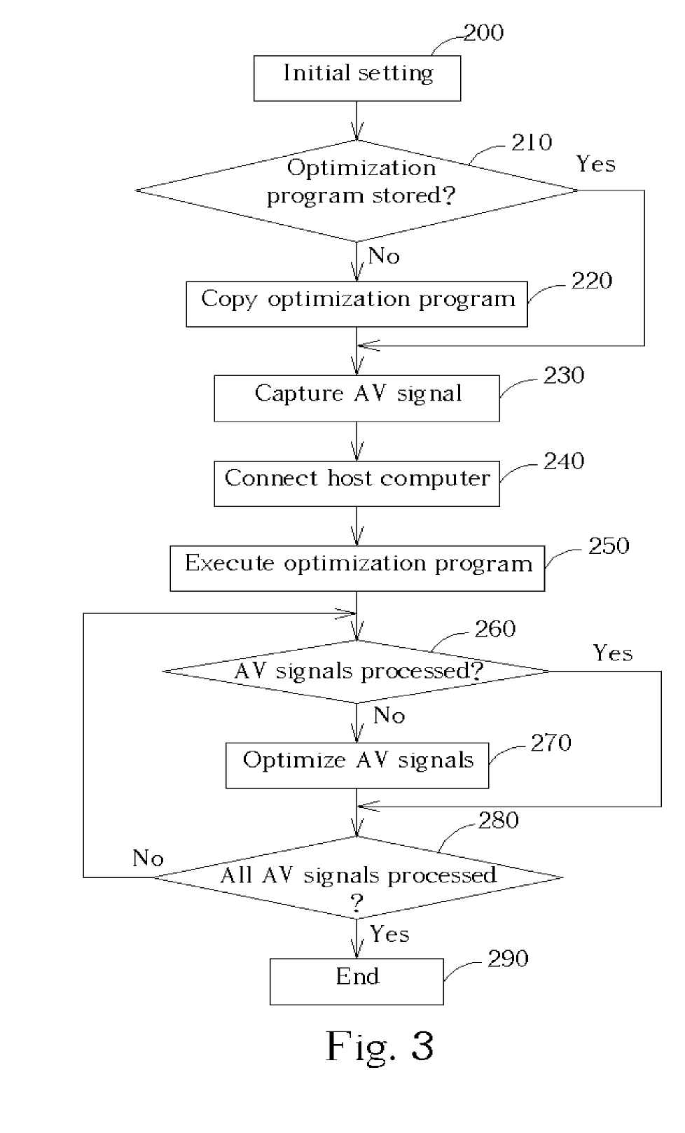

Please refer to FIG. 3 showing a flowchart of the method for optimizing AV signals according to the present invention. The optimization program 18 is stored in the digital camera 10 in FIG. 1, and the images captured by the digital camera 10 are stored in the memory card 16. The digital camera 10 processes the AV signals as follows:

Step200: If the digital camera 10 uses the external memory card 16, initially set up the memory card 16, which means recording the storing format of the digital camera 10 into the memory card 16.

Step210: See if the optimization program 18 is stored in the memory card 16. If no, proceed Step220, and if yes, proceed Step230.

Step220: Copy the optimization program 18 stored in the built-in memory 14 into the memory card 16.

Step230: Capture the AV signals by the digital camera 10. The AV signals can be a picture, an audio file, or a motion picture file. The AV signals captured by the digital camera 10 are stored in the built-in memory 14 and the memory card 16.

Step240: Connect the digital camera 10 and the memory card 16 to the host computer 22 in order to browse, edit, or print the AV signals captured by the digital camera 10.

Step250: When the digital camera 10 or the memory card 16 is connected to the host computer 22, the host computer 22 automatically executes the optimization program 18. The optimization program 18 optimizes the AV signals captured by the digital camera 10 and attaches the index to the AV signals optimized.

Step260: See if the AV signals captured by the digital camera 10 have the index. If no, proceed Step270, and if yes, proceed Step280.

Step270: Execute the optimization program 18 using the host computer 22 and store the processed AV signals to their original place to rewrite the original data. The optimization program 18 is capable of improving the noise, brightness and color of the images captured by the digital camera 10.

Step280: See if all the data in the built-in memory 14 and the memory card 16 is optimized. If yes, proceed Step290, and if no, proceed Step260;

Step290: End the optimization program 18.

As mentioned above, the AV device and the method for optimizing AV signals provides the optimization program to optimize the AV signals captured by the AV device. The AV device stores the optimization program and the captured AV signals into the memory. The host computer automatically processes the optimization program when the memory is connected to the host computer. The optimization program processes the AV signals captured by the AV device so that the processed AV signals rewrite the original AV signals, and attaches the index to the processed AV signals for identification to prevent double processing.

In contrast to the prior art, the AV device and the method for optimizing AV signals according to the present invention uses the optimization program to optimize the AV signals captured by the AV device, in order to supplement the insufficiency of the hardware. The optimization program improves the AV signals captured by the AV device, so that the user is no longer required to learn special techniques. Additionally, the AV device can use lower price photo sensors even if they capture only signals in low quality, because those signals can be optimized by the optimization program then. Moreover, the optimization program is built in the AV device, and executed automatically by the CPU of the host computer when the AV device is connected to the host computer. The execution is rapid and is not limited to a specific computer.

Those skilled in the art will readily observe that numerous modifications and alterations of the device and the method may be made while retaining the teachings of the invention. Accordingly, the above disclosure should be construed as limited only by the metes and bounds of the appended claims.

1. A method for optimizing audiovisual (AV) signals comprising:
storing an optimization program in a memory of an AV device; and
executing the optimization program by a host computer to process the AV signals stored in the memory after connecting the memory to the host computer.

2. The method of claim 1, further comprising storing the AV signals processed by the optimization program back to the memory.

3. The method of claim 1, further comprising attaching an index to the AV signals processed by the optimization program.

4. The method of claim 1, wherein the optimization program is copied to a memory of the host computer before the host computer executes the optimization program.

5. The method of claim 1, wherein the optimization program is for optimizing the AV signals stored in the memory.

6. The method of claim 1, wherein the optimization program is copied from a read-only memory (ROM) of the AV device to the memory of the AV device.

7. The method of claim 1, wherein the AV device is a digital camera.

8. The method of claim 1, wherein the AV device is a digital recorder.

9. A device implementing the method of claim 1.

10. An audiovisual (AV) device comprising:
an optimization program executed by a host computer when the AV device is connected to the host computer, in order to optimize AV signals captured by the AV device; and
a memory for storing the optimization program and the AV signals captured by the AV device.

11. The AV device of claim 10, being a digital camera.

12. The AV device of claim 10, being a digital recorder.

13. The AV device of claim 10, further comprising a ROM for storing the optimization program.
